(19) United States
(12) Patent Application Publication
(10) Pub. No.: US 2013/0093590 A1
(43) Pub. Date: Apr. 18, 2013

(54) Tracking location of Jewelry for theft prevention

(71) Applicant: Chandra Madhavan Sivalingam, Sandy Springs, GA (US)

(72) Inventor: Chandra Madhavan Sivalingam, Sandy Springs, GA (US)

(21) Appl. No.: 13/275,431

(22) Filed: Oct. 18, 2011

(51) Int. Cl. G08B 13/14; A44C 19/00

(52) U.S. Cl. 340/571; 63/1.11

(57) ABSTRACT

Disclosed is a jewelry item to which a location tracking module can be attached. The location tracking module could use a GPS circuit or a GPS circuit. A geo fence can be defined around the jewelry item. If the jewelry is taken out of the geo fence, a message or an alarm may be sent to specified phone numbers and email IDs.

### CROSS-REFERENCE TO RELATED APPLICATIONS

Not Applicable

### STATEMENT REGARDING FEDERALLY SPONSORED RESEARCH AND DEVELOPMENT

Not Applicable.

### FIELD OF THE INVENTION

The present invention relates generally to the field of theft prevention, and more particularly to the field of theft prevention of jewelry.

### DISCUSSION OF RELATED ART

Jewelry is one of the most precious assets that a family can possess. Because of the high value of jewelry, jewelry is usually the first target of thieves and burglars. Through the ages, man has developed various means for protection of jewelry from thieves and burglars. Steel safes and lockers with sophisticated locks of various types are the traditional ways of protecting jewelry. However, safes and lockers are vulnerable to loss of keys, making of duplicate keys, cutting of metal by gas flames, etc.

Further, the existing safes and lockers are of no use after a thief has somehow managed to penetrate the safes or lockers and decamped with the jewelry. There is no way to track the jewelry after it is stolen.

Accordingly, a need exists for a smart way of tracking jewelry if it is stolen.

### SUMMARY OF INVENTION

The problem of tracking a jewelry item if it is stolen is solved by attaching to the jewelry item a location tracking module and communicating its location to the jewelry owner or a law enforcement agency.

In an embodiment, the location tracking module may include a circuit using a satellite-based global positioning (GPS) technology. In another embodiment, the module may include a circuit using a GPRS technology. In other embodiments, the circuit embedded in the jewelry item may be a universal communicator that has the ability to communicate with a variety of devices, for example, an e RFID reader, a Wi-Fi device, a GSM device, a UMTS device, an LTE device, a Bluetooth device, an IR device, etc. Different embodiments may use various combinations and sub-combinations of the communication devices listed above.

In an embodiment, the module may include a rechargeable battery. The battery may be charged without having to remove the battery from the module by using inductive charging mats.

In an embodiment, the module may be configurable to define boundaries of a geo fence around the jewelry item such that when the jewelry item is moved outside the geo fence, a message and/or an alarm may automatically be sent to an owner or a law enforcement agency. The message may be a real-time update about the location of the jewelry item and may be sent periodically.

In an embodiment, the module may include a SIM card and the boundaries of the geo fence can be configured by sending an SMS to the module. The module may be enabled or disabled by sending an SMS to the module.

### BRIEF DESCRIPTION OF THE DRAWINGS

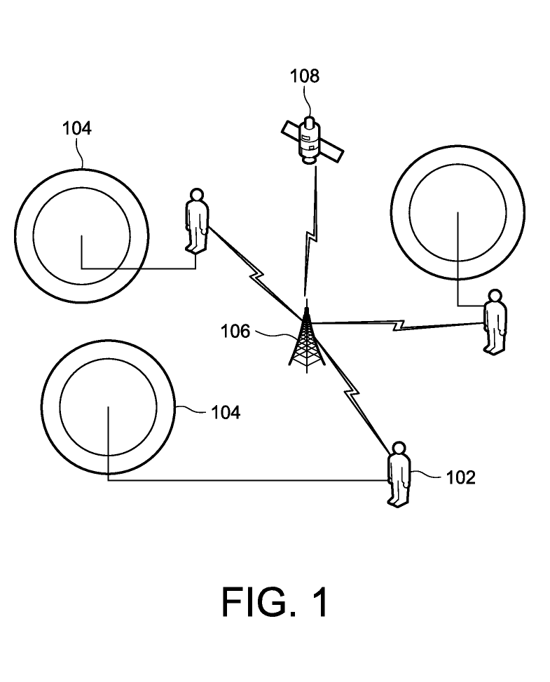

According to an embodiment, FIG. 1 shows an example of a system for tracking a jewelry item using a GPRS network and a GPS network.

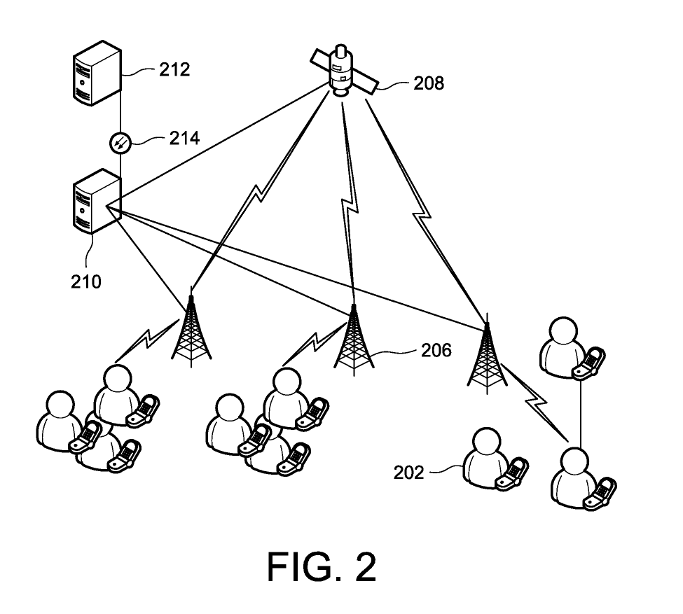

According to an embodiment, FIG. 2 shows an example of system for tracking a jewelry item using a GPRS network, a GPS network, and a network server connected to the GPRS network and the GPS network.

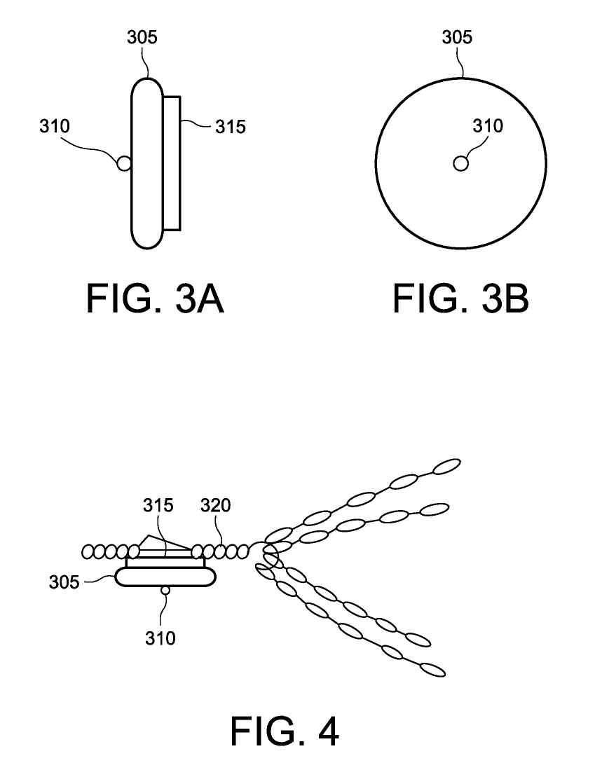

According to an embodiment, FIG. 3A and FIG. 3B show a side view and a front view respectively of a location tracking module that may be embedded inside a jewelry item.

According to an embodiment, FIG. 4 shows an exemplary way of embedding a location tracking module in a jewelry item.

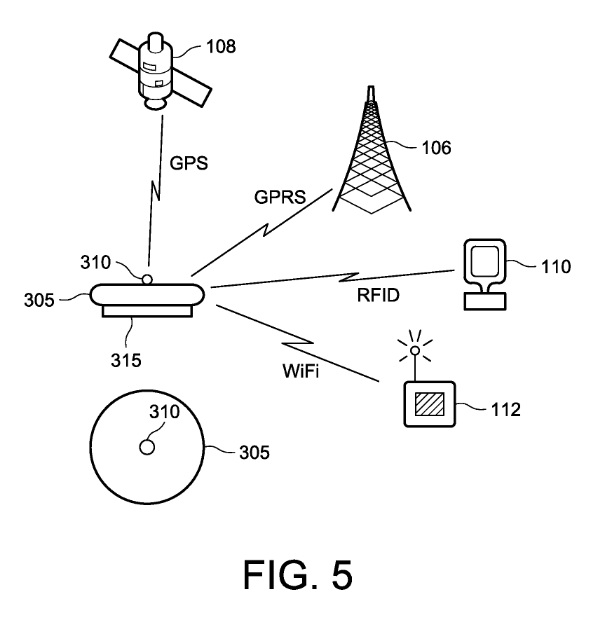

According to an embodiment, FIG. 5 shows an exemplary system for tracking the location of a jewelry item using a range of technologies, e.g., GPS, GPRS, RFID, Wi-Fi, etc.

### DETAILED DESCRIPTION OF THE PREFERRED EMBODIMENTS

The problem of tracking a jewelry item if it is stolen is solved by attaching to the jewelry item a location tracking module.

The dimensions of all components are not to scale and the actual proportions of different components could be different from the proportions shown in the appended drawings.

In an embodiment, the module for determining the location may include a circuit employing satellite-based global positioning technology, such technology also known as GPS technology and such circuits also known as GPS circuits. In an embodiment, the location tracking module may be a miniature GPS circuit that is small enough to be attached to a jewelry item. In an embodiment, the location tracking module for determining the location may be a circuit employing GPRS technology. In another embodiment, the module may have an RFID tag. The module embedded inside the jewelry item may be a universal communicator that has the ability to communicate with a variety of devices, for example, an e RFID reader, a Wi-Fi device, a GSM device, a UMTS device, an LTE device, a Bluetooth device, an IR device, etc. Different embodiments may use various combinations and sub-combinations of the communication devices listed above.

The location tracking module attached to the jewelry item may be adapted to the size and shape of the jewelry item. The location tracking module should preferably be smaller than the jewelry item to which it is to be attached so that the appearance of the jewelry is not affected by attachment of the location tracking circuit.

The location tracking module may be integrated into a small enclosure that is embedded in the jewelry item. In other embodiments, the location tracking module may be attached to the jewelry item without use of an enclosure. The enclosure may have a battery compartment from which a battery can removed or to which a battery may be added. The battery may preferably be a rechargeable battery.

In an embodiment shown in FIG. 1, a jewel attached with a location tracking module is being tracked by a GPRS network and a GPS network. The GPRS network consists of a plurality of GPRS towers 106. The GPS network is controlled by one or more space satellites 108. A geo fence 104 can be defined around a jewelry item (for example, a jewel). When a thief 102 steals the jewelry item and moves outside the geo fence 104, the location tracking module in the jewelry item communicates with the GPRS/GPS network, tracks the location of the jewelry item, and sends messages/alerts to the owner of the jewelry item or to a law enforcement agency.

In an embodiment shown in FIG. 2, a jewel 202 attached with a location tracking module is being tracked by a network. The GPRS network consists of a plurality of GPRS towers 206. The GPS network is controlled by one or more space satellites 208. Initially the jewel is tracked on a GPRS (cellular) network and when it is outside the range of the GPRS network, it is synchronized with a GPS network. Although the GPRS network is expected to be up 99.99% of time, the connection may be switched to the GPS network whenever the GPRS network is down. The jewel can be tracked even when it is outside the GPRS network. All these can be monitored and tracked though a network server 212. The network server 212 has a database containing information (e.g., owner contact details, owner subscription details, billing details, etc.,) of all the Jewel Location Trackers. The network server 212 is connected to a GPRS service provider 210 using an optical fiber connection 214. In an embodiment, the network server 212 may be a third party provider. In other embodiments, the connection between the network server 212 and the GPRS service provider 210 could be alternatives like copper, wireless media, etc.

According to an embodiment, FIG. 3A and FIG. 3B show a side view and a front view respectively of a location tracking module 305 that may be embedded inside a jewelry item. It may be noted that the actual size of the location tracking module 305 is substantially smaller than the size shown in FIGS. 3, 4, and 5. The location tracking module 305 is shown bigger in size than the actual size for better legibility and clarity only. An antenna 310 and a battery 315 may be attached to the location tracking module 305. The module 305 may have electronic circuitry (not shown) that enables the module 305 to communicate wirelessly using a range of technologies, e.g., GPS, GPRS, RFID, Wi-Fi, etc.

In an embodiment, the battery 315 attached to the jewelry tracking module 305 may be a rechargeable battery having capacity of say 500 mAh. The module may have a USB socket which can be used to charge the battery. Alternatively, the battery may be charged by using inductive charging mats.

According to an embodiment, FIG. 4 shows an exemplary way of embedding a location tracking module 305 in a jewelry item 320. An antenna 310 and a battery 315 may be attached to the jewelry tracking module 305. The size of the module 305 has to be same or less than that of the jewelry item 320. In an embodiment, the module 305 may be embedded inside the jewelry item 320 and and is thus becomes hidden from view.

According to an embodiment, FIG. 5 shows an exemplary system for tracking the location of a jewelry item using a range of technologies, e.g., GPS, GPRS, RFID, Wi-Fi, etc. An antenna 310 and a battery 315 may be attached to a is location tracking module 305. The module 305 may have electronic circuitry (not shown) inside the module 305 enabling the module 305 to track and communicate its geographical coordinates using a range of technologies, for example but not limited to GPS, GPRS, RFID, Wi-Fi, etc. The location tracking module 305 may communicate wirelessly with any combination of a GPS satellite 108, a GPRS tower 106, an RFID reader 110, or a Wi-Fi network 112.

In an embodiment, the battery inside the enclosure may be a rechargeable 500 mAh battery. The battery may be charged by inductive charging mats. In another embodiment, the enclosure may have a USB socket which can be used to charge the battery. In both the embodiments, the battery does not have to be removed from the enclosure for charging.

In an embodiment, the location tracking module may be configured such that automatic alerts and/or alarms may be sent to specified phones/email IDs when the jewelry item is taken out of a defined geo fence around the defined location of the jewelry item. The message may be a real-time update about the location of the jewelry item and may be sent at periodic intervals.

In an embodiment, the location tracking module may include a SIM card and the geo fencing on the location tracking module may be configured in various ways, for example by sending an SMS to the location tracking module.

In an embodiment, the location tracking module may be enabled or disabled by sending an SMS to the module.

It is understood that any specific location tracking module or hierarchy of steps in any disclosed process shows an exemplary approach. Based upon design preferences, it is understood that the specific order or hierarchy of steps in the processes may be rearranged while remaining within the scope of the present disclosure. The accompanying method claims present elements of the various steps in an exemplary order, and are not meant to be limited to the specific order or hierarchy presented.

The previous description of the disclosed aspects is provided to enable any person skilled in the art to make or use the present disclosure. While a particular form of the invention has been illustrated and described, it will be apparent that various modifications can be made without departing from the spirit and scope of the invention. Accordingly, it is not intended that the invention be limited, except as by the appended claims. Various modifications to these aspects will be readily apparent to those skilled in the art, and the generic principles defined herein may be applied to other aspects without departing from the scope of the disclosure. The above detailed description of the embodiments of the invention is not intended to be exhaustive or to limit the invention to the precise form disclosed above or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other articles, not necessarily the article described above. The elements and acts of the various embodiments described above can be combined to provide further embodiments.

The above description provides specific details for a thorough understanding of the invention. One skilled in the art will understand that the invention may be practiced without such details. In other instances, well-known structures and functions have not been shown or described in detail to avoid unnecessarily obscuring the description of the embodiments.

The word “exemplary” is used in this description to mean “serving as an example, instance, or illustration”. Any embodiment described herein as “exemplary” is not necessarily to be construed as preferred or advantageous over other embodiments. Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list.

Particular terminology used when describing certain features or aspects of the invention should not be taken to imply that the terminology is being redefined herein to be restricted to any specific characteristics, features, or aspects of the invention with which that terminology is associated. In general, the terms used in the appended claims should not be construed to limit the invention to the specific embodiments disclosed in the specification, unless the Detailed Description section explicitly defines such terms. Accordingly, the actual scope of the invention encompasses not only the disclosed embodiments, but also all equivalent ways of practicing or implementing the invention.

All listed patents, applications, and other references, including any that may be listed in the accompanying filing papers, are incorporated herein by reference. Aspects of the invention can be modified, if necessary, to employ the systems, functions, and concepts of the various references described above to provide yet further embodiments of the invention.

While certain aspects of the invention are presented below in certain claim forms, the inventor reserves the right to add additional claims after filing the application to pursue such additional claim forms for other aspects of the invention.

What is claimed is:

1. A jewelry item modified for safe keeping, comprising a location tracking module attached to the jewelry item, the module having dimensions less than those of the jewelry item.

2. The jewelry item of claim 1, wherein the module is embedded inside the jewelry to item.

3. The jewelry item of claim 1, wherein the location tracking module comprises a circuit using a satellite-based global positioning technology.

4. The jewelry item of claim 1, wherein the location tracking module comprises a circuit using a GPRS technology.

5. The jewelry item of claim 2, wherein the module embedded inside the jewelry item is hidden to the eye.

6. The jewelry item of claim 1, wherein the module comprises a rechargeable battery.

7. The jewelry item of claim 6, wherein the battery can be charged without having to remove the battery from the module.

8. The jewelry item of claim 7, wherein the battery is charged using inductive charging mats.

9. The jewelry item of claim 1, configurable to define boundaries of a geo fence around the jewelry item such that when the jewelry item is moved outside the geo fence, at least one of a message and an alarm are automatically sent to at least one of an owner and a law enforcement agency.

10. The jewelry item of claim 9, wherein the module further comprises a SIM card and wherein the boundaries of the geo fence can be configured by sending an SMS to the module.

11. The jewelry item of claim 10, wherein the module can be enabled or disabled by sending an SMS to the module.

12. A method for safekeeping of jewelry, comprising:
embedding a location tracking module inside a jewelry item, the module having dimensions less than those of the jewelry item;
configuring boundaries of a geo fence around the jewelry item; and
if the jewelry item is moved outside the defined geo fence, sending automatically at least one of a message and an alarm to at least one of an owner and a law enforcement agency.

13. The method of claim 12, wherein the message is periodic and further comprises a real-time update about the location of the jewelry item.

14. The method of claim 12, wherein the location tracking module comprises a circuit using a satellite-based global positioning technology.

15. The method of claim 12, wherein the location tracking module comprises a circuit using a GPRS technology.

16. The method of claim 12, wherein the module embedded inside the jewelry item is hidden to the eye.

17. The method of claim 12, wherein the module comprises a rechargeable battery.

18. The method of claim 17, wherein the battery can be charged by inductive charging mats without having to remove the battery from the module.

19. The method of claim 12, wherein the module further comprises a SIM card and wherein the boundaries of the geo fence can be configured by sending an SMS to the module.

20. The method of claim 19, wherein the module can be enabled or disabled by sending an SMS to the module.
